(19) United States
(12) Patent Application Publication
(10) Pub. No.: US 2014/0293904 A1
(43) Pub. Date: Oct. 2, 2014

(54) Systems and Methods for Sparse Beamforming Design

(71) Applicant: FutureWei Technologies, Inc., Plano, TX (US)

(72) Inventors: Binbin Dai, Toronto (CA); Wei Yu, Toronto (CA); Mohammadhadi Baligh, Kanata (CA)

(73) Assignee: FUTUREWEI TECHNOLOGIES, INC., Plano, TX (US)

(21) Appl. No.: 14/227,724

(22) Filed: Mar. 27, 2014

Related U.S. Application Data
(60) Provisional application No. 61/806,144, filed on Mar. 28, 2013.
(60) Provisional application No. 61/927,913, filed on Jan. 15, 2014.

(51) Int. Cl. H04L 5/00; H04B 7/04; H04B 7/02

(52) U.S. Cl. CPC H04L 5/0073; H04L 5/0035; H04B 7/024; H04B 7/0452
USPC 370/329

(57) ABSTRACT

System and method embodiments are provided for sparse beamforming design. In an embodiment, a method of designing sparse transmit beamforming for a network multiple-input multiple output (MIMO) system includes dynamically forming, by a cloud central processor, a cluster of transmission points (TPs) for use in transmit beamforming for each of a plurality of user equipment (UEs) in the system by optimizing a network utility function and system resources; determining, by the cloud central processor, a sparse beamforming vector for each UE according to the optimizing; and transmitting, by the cloud central processor, a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

### CROSS-REFERENCE TO RELATED APPLICATIONS

The present application claims the benefit of U.S. Provisional Patent Application No. 61/806,144 filed Mar. 28, 2013 and titled “System and Method for Sparse Beamforming Design,” and U.S. Provisional Patent Application No. 61/927,913 filed Jan. 15, 2014 and titled “System and Method for Sparse Beam Forming Design for Networked MIMO Systems with Limited Backhaul,” both of which are incorporated herein by reference as if reproduced in their entirety.

### TECHNICAL FIELD

The present invention relates to a system and method for wireless communications, and, in particular embodiments, to a system and method for sparse beamforming design.

### BACKGROUND

Wireless cellular networks are increasingly deployed with progressively smaller cell sizes in order to support the demand for high-speed data. As a consequence, intercell interference is one of the main physical-layer bottlenecks in cellular networks. Multicell cooperation, which allows neighboring base stations (BSs) to cooperate with each other for joint precoding and joint processing of user data, is a promising technology for intercell interference mitigation. This emerging architecture, also known as network multiple-input multiple-output (MIMO), has the potential to significantly improve the overall throughput of the cellular network.

The idealized implementation of multicell cooperation, where all BSs in the entire network cooperate and share the data for all users, is impractical. One way to implement multicell cooperation in practice is to connect all the BSs with a central processor (CP) via rate-limited backhaul links. For downlink transmission, the CP then only needs to distribute the user's data to its serving BSs. Roughly speaking, there are two conventional schemes to determine the set of serving BSs for each user: fixed clustering and user-centric clustering. In fixed clustering scheme, a fixed set of neighboring BSs are grouped together into a larger cluster to coordinately serve the users within the coverage. Although the fixed clustering scheme has already shown reasonable performance gain, in such a scheme users at the cluster edge still suffer from considerable inter-cluster interference which limits the benefits of network MIMO. In user-centric clustering where the BS clusters are not fixed but are determined for each user individually, each user dynamically selects a set of favorable BSs; these BSs then cooperatively serve the user using joint precoding techniques. The benefit of user-centric clustering is that it has no explicit cluster edges.

Determining the best set of serving BSs for each user is not a straightforward task. From the users' perspective, each user wishes to be served by as many cooperating BSs as possible, while from the BSs' perspective, serving more users consumes more power and backhaul capacity. There exists therefore a tradeoff between the user rates, the transmit power, and the backhaul capacity. Further, the beamformer design problem for the network MIMO system with user-centric clustering is also nontrivial, because the sets of BSs serving different users may overlap. The traditional zero-forcing (ZF) beamforming and minimum mean square error (MMSE) beamforming designs specifically developed for the single cell case cannot be simply re-used.

### SUMMARY

In an embodiment, a method of designing sparse transmit beamforming for a network multiple-input multiple output (MIMO) system includes dynamically forming, by a cloud central processor, a cluster of transmission points (TPs) for use in transmit beamforming for each of a plurality of user equipment (UEs) in the system by optimizing a network utility function and system resources; determining, by the cloud central processor, a sparse beamforming vector for each UE according to the optimizing; and transmitting, by the cloud central processor, a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

In an embodiment, a cloud central processor configured to design sparse transmit beamforming for a network multiple-input multiple output (MIMO) system includes a processor and a computer readable storage medium storing programming for execution by the processor, the programming including instructions to: dynamically form a cluster of transmission points (TPs) for use in transmit beamforming for each of a plurality of user equipment (UEs) in the system by optimizing a network utility function and system resources; determine a sparse beamforming vector for each UE according to the optimizing; and transmit a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

In an embodiment, a system of designing sparse transmit beamforming for a network multiple-input multiple output (MIMO) system with limited backhaul includes a cloud central processor and a plurality of transmission points coupled to the cloud central processor by backhaul links and configured to serve a plurality of user equipment, wherein the cloud central processor is configured to: dynamically form a cluster of transmission points (TPs) for use in transmit beamforming for each of a plurality of user equipment (UEs) in the system by optimizing a network utility function and system resources; determine a sparse beamforming vector for each UE according to the optimizing; and transmit a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a schematic diagram of an embodiment network MIMO system with per-BWS backhaul constraints;

FIG. 2 illustrates a flow diagram for an embodiment method for sparse beamforming for maximizing network utility for variable-rate applications under radio resource limits;

FIG. 3 illustrates an embodiment system of BSs connected to a central cloud processor via a limited backhaul;

FIG. 4 illustrates a flow diagram for an embodiment method for sparse beamforming with a limited backhaul via reweighted power; and

FIG. 5 is a block diagram of a processing system that may be used for implementing the devices and methods disclosed herein.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Sparse beamforming design under fixed user rate constraints can be addressed using a variety of techniques. Some authors in the field propose to approximate the discrete lₒ-norm through a series of smooth exponential functions. Alternatively, others use the l₁-norm of the beamforming vector to approximate the cluster size, which can be further improved by reweighting. The cluster size can be determined from the l₂-norm of the beamformers at each BS, and the resulting optimization problem becomes a second-order cone programming (SOCP) problem, which can be solved numerically by the interior-point method. To reduce the computational complexity of the interior-point method, some prior art solutions employ a second algorithm, which first solves the sum power minimization problem, then iteratively removes the links corresponding to the least link transmit power.

Network utility optimization problem for network MIMO system also has been considered in previous literature. For instance, sum rate maximization for fixed clustering scheme where the block diagonalization precoding method originally designed for the MIMO broadcast channels is generalized to accommodate inter-cluster interference mitigation. Utility maximization has also been considered for predetermined user-centric clustering and for dynamic user-centric clustering. Others have proposed to approximate the nonconvex rate expression using the first order Taylor expansion to transform the problem into a convex optimization problem while resorting to the generalized version of WMMSE approach to find a local optimal solution. Joint beamforming and user-centric clustering design has been investigated by imposing an l₂-norm approximation of the cluster size as a penalized item onto the traditional weighted sum rate (WSR) maximization problem. Placing the cluster size constraint onto the objective function results in the power constraints separable between the BSs, which makes the existing block coordinate descent (BCD) algorithm applicable. From the system design perspective, however, this also makes it hard to control the backhaul consumption at each BS since one has to carefully choose the price terms to make the final beamforming vector have the desired sparsity. Furthermore, some of these methods restrict the candidate BSs serving each user within each cell. This restriction shares the common drawback as fixed clustering that the users at the cluster edge may still suffer from considerable inter-cell interference.

Practical design for network MIMO system with limited cooperation has been intensively studied. Joint user scheduling and dynamic clustering design has been considered, while joint clustering and beamforming design has been investigated by adding an f₂-norm approximation of cluster size for each user as a penalized item onto the weighted sum rate maximization problem. Others have proposed to solve the problems of cluster selection, user scheduling, beamforming design and power allocation in a decoupled fashion. In a method that is different from those in which zero-forcing (ZF) beamforming is employed, still others have proposed a so called soft interference nulling (SIN) precoding technique for a fixed cluster by solving a sequence of convex optimization problems, which performs at least as well as ZF beamforming.

Several different algorithms have been proposed to solve the optimization problems. In one algorithm, the cluster size is approximated by weighted f₂-norm and formulated the problem into a second-order cone programming (SOCP) problem, which is then solved numerically by using an interior-point method. To reduce the high computational complexity of this interior-point method, a second algorithm has been proposed to first solve the sum power minimization problem and then iteratively remove the links that correspond to the smallest link transmit power.

In the existing art, the idea of compressive sensing has been applied to various scenarios in communication system design. For example, some have designed sparse MMSE receivers for the uplink multicell cooperation model using the l₁-norm approximation, while others use similar idea for joint power and link admission control in an interference channel. Moreover, others have applied the idea to the green cloud radio access network (Cloud-RAN) to jointly minimize the transmit power from the BSs and the transport power from the backhaul links. However, all of these methods suffer from computational complexity issues that render them impractical to implement.

Disclosed herein, is a compressive sensing method and system to deal with the cluster formulation problem in network MIMO system, where the discrete tₒ-norm is approximated by the reweighted t₂-norm square of the beamformers. By utilizing this approximation approach, the network MIMO system designs with limited backhaul are simplified.

In an embodiment, a downlink multicell cooperation model in which the base-stations (BSs) are connected to a central processor (CP) via rate-limited backhaul links is presented using a user-centric clustering model where each scheduled user is cooperatively served by a cluster of BSs, and the serving BSs for different users may overlap. Two different problem formulations are considered respectively, i.e. optimal tradeoff between the total transmit power and the sum backhaul capacity under fixed user rate constraints, and utility maximization for given per-BS power and per-BS backhaul constraints. Approximation of the backhaul rate as a function of the weighted l₂-norm square of the beamformers is used. This allows a tradeoff problem to be converted into a weighted power minimization problem, which then can be solved efficiently using the well-known uplink-downlink duality approach; it also makes the utility maximization problem solvable through a generalized weighted minimum mean square error (WMMSE) approach.

In an embodiment, disclosed herein is a method and system to solve a joint beamforming and clustering design problem in a downlink network multiple-input multiple-output (MIMO) setup, where the base-stations (BSs) are connected to a central processor with rate-limited backhaul links. In an embodiment, the problem is formulated as that of devising a sparse beamforming vector across the BSs for each user, where the nonzero beamforming entries correspond to that user's serving BSs. In an embodiment, the utility function is the weighted sum rate of users. Different from other solutions, disclosed herein is a method in which the per-BS backhaul constraints are formulated in the network utility maximization framework. In contrast to the traditional utility maximization problem with transmit power constraints only, the additional backhaul constraints result in a discrete l₀-norm formulation, which makes the problem more challenging. In an embodiment, disclosed herein is a method and system to iteratively approximate the per-BS backhaul constraints using a weighted l₁-norm technique and reformulate the backhaul constraints as weighted per-BS power constraints. This approximation allows one to solve the weighted sum rate maximization problem iteratively through a generalized weighted minimum mean square error (WMMSE) approach. To reduce computational complexity of the proposed methods within each iteration, disclosed are two additional techniques: iterative link removal and iterative user pool shrinking, which dynamically decrease the potential BS cluster size and user scheduling pool. Numerical results show that the disclosed methods and systems can significantly improve the system throughput as compared to the nave BS clustering strategy based on the channel strength.

Disclosed herein is an embodiment method of designing sparse transmit beamforming for a network multiple-input multiple-output (MIMO) system includes a cloud central processor iteratively minimizing system resources in the system, subject to one or more user experience constraints with updated weights. In a further embodiment, the system resources are a weighted sum of the transmit powers and the backhaul rates. In an additional embodiment, the one or more user experience constraints are selected from the group consisting of signal plus interference to noise ratio (SINR), data rate, and a combination thereof.

Disclosed herein are methods and systems of designing sparse transmit beamforming for a network multiple-input multiple output (MIMO) system. In an embodiment, a method includes dynamically and adaptively forming, by a cloud central processor, a cluster of transmission points (TPs) for use in transmit beamforming for each of a plurality of user equipment (UEs) in the system by optimizing a network utility function and system resources, determining, by the cloud central processor, a sparse beamforming vector for each user equipment according to the forming the cluster; and transmitting, by the cloud central processor, a message and first beamforming coefficients to ones of the transmission points that form the cluster of TPs for a first user equipment, wherein the ones of the transmission points that form the cluster of TPs for the first user equipment correspond to nonzero entries in a first beamforming vector corresponding to a first user equipment. In an embodiment, dynamically and adaptively forming a cluster of TPs includes one of maximizing a utility function with fixed system resources and minimizing system resources with a given user experience constraint. In an embodiment, the utility function includes a weighted sum rate and the system resources include transmit power and backhaul rates. In an embodiment, forming the cluster includes iteratively optimizing, by the cloud central processor, one of a first function and a second function, wherein iteratively optimizing the first function includes iteratively minimizing required system resources to support at least one desired user experience constraint, and wherein iteratively optimizing the second function includes iteratively maximizing a utility function of user transmission rates with pre-specified system resource constraints, wherein the system includes a plurality of transmission points (TPs) and a plurality of user equipment. In an embodiment, the utility function is a weighted rate sum of user rates and wherein the pre-specified system resources constraints include transmit power constraints and backhaul rate constraints.

In an embodiment, the method includes iteratively removing a first one of the TPs from a user's candidate cluster once transmit power from the first TP to the user is below a threshold. In an embodiment, the method further includes ignoring a first one of the user equipment when an achievable user transmission rate for the first one of the user equipment is below a threshold. In an embodiment, iteratively minimizing required system resources comprises minimizing a weighted sum of transmit powers and backhaul rates, and wherein the at least one desired user experience constraint comprises user transmission data rates.

In an embodiment iteratively maximizing a utility function of user transmission rates with pre-specified system resource constraints includes iteratively computing a minimum mean square error (MMSE) receiver and a corresponding MSE; updating an MSE weight; finding an optimal transmit beamformer under a fixed utility function and MSE weight; computing an achievable transmission rate for a user equipment, k; and updating a fixed transmission rate and a fixed weight to be equal to the achievable transmission rate. In an embodiment, computing the MMSE receiver and the corresponding MSE comprises computing

uₖ=(ΣⱼHₖwⱼwⱼ^{H}Hₖ^{H}+σ²I)⁻¹Hₖwₖ,∀k,

where uₖ is the MMSE receiver, Hₖ is channel state information from all the TPs to user k, wⱼ is the beamforming vector for a j^{th} user equipment, wherein a superscript H denotes a Hermitian Transpose in matrix operation, is a received noise power, and I is an identity matrix and computing

$${e}_{k} = E [ {‖ {u}_{k}^{H} {y}_{k} - {s}_{k} ‖}_{2}^{2} ] = {u}_{k}^{H} ( {\sum }_{j} {H}_{k} {w}_{j} {w}_{j}^{H} {H}_{k}^{H} + {σ}^{2} I ) {u}_{k} - 2 Re \{ {u}_{k}^{H} {H}_{k} {w}_{k} \} + 1$$

where eₖ is the corresponding MSE, E is an expectation operator, uₖ^{H} is the Hermitian Transpose of a receive beamformer for user k, yₖ is a receive signal at user k, and sₖ is intended data for user k. In an embodiment, ρₖ is the MSE weight and updating the MSE weight includes computing ρₖ according to ρₖ=eₖ⁻¹. In an embodiment, the achievable rate is R and computing the achievable rate includes computing R according to

Rₖ=log(1+wₖ^{H}Hₖ^{H}(Σ_{j≠k}Hₖwⱼwⱼ^{H}Hₖ^{H}+σ²I)⁻¹Hₖwₖ).

In an embodiment, \hat{R}ₖ is the fixed transmission rate and updating the fixed transmission rate and the fixed weight includes setting \hat{R}ₖ=Rₖ and computing βₖ^{l} according to

$${β}_{k}^{l} = \frac{1}{{‖ {w}_{k}^{l} ‖}_{2}^{2} + τ} , ∀ k , l ,$$

where αₖ^{l} is the fixed weight for wₖ^{l}, ∥wₖ^{l}∥₂² is a transmit power from TP l to user k, and τ is a regularization constant.

In an embodiment, optimizing includes iteratively minimizing a function of transmission powers and backhaul rates according to:

$$\begin{matrix}minimize \\ {w}_{k}^{l}\end{matrix} {\sum }_{k , l} {α}_{k}^{l} {‖ {w}_{k}^{l} ‖}_{2}^{2} subject to {SINR}_{k} \geq {γ}_{k} , ∀ k$$

where αₖ^{l}=ρₖ^{l}Rₖ+η, where ρₖ^{l} is a weight associated with each transmission point-user equipment pair, Rₖ is an effective transmission rate of user k, and η is a scalar; finding an optimal dual variable using a fixed-point method; computing an optimal dual uplink receiver beamforming vector; updating the beam forming vector and δₖ, wherein δₖ is a scaling factor relating uplink optimal receiver beamforming and downlink optimal transmit beamforming; and updating weights, ρₖ^{l} associated with each transmission point-user equipment pair, according to:

$${ρ}_{k}^{l} = \frac{1}{{‖ {w}_{k}^{l} ‖}_{2}^{2 p} + {ε}^{p}}$$

where p is some positive exponent and ε is adaptively chosen to be ε=max {(min_{k,l}∥wₖ^{l}∥₂²),τ} and τ is some small positive value, and wherein αₖ^{l} is updated according to αₖ^{l}=ρₖ^{l} Rₖ+η, where η represents a tradeoff factor between backhaul rates and transmit powers. In an embodiment, the optimal dual variable is λₖ for a k^{th} user and finding the optimal dual variable includes determining λₖ according to:

$${λ}_{k} = \frac{{γ}_{k}}{{{h}_{k}^{H} ( {\sum }_{j \neq k} {λ}_{j} {h}_{j} {h}_{j}^{H} + {B}_{k} )}^{- 1} {h}_{k}} ,$$

where γₖ is SINR target for user k, hₖ^{H} is Hermitian transpose of channel state information vector to user k, hⱼ is channel state information for user j, hⱼ^{H} is Hermitian transpose of channel state information for user j, and Bₖ is dual uplink noise covariance matrix. In an embodiment, the optimal dual uplink receiver beamforming vector is ŵₖ and computing the optimal dual uplink receiver beamforming vector includes determining ŵₖ according to:

ŵₖ=(Σⱼλⱼhⱼhⱼ^{H}+Bₖ)⁻¹hₖ.

In an embodiment, the beamforming vector is wₖ, and updating the beamforming vector and updating δₖ includes determining wₖ according to wₖ=\sqrt{δₖ}ŵₖ and determining δₖ according to δ=F⁻¹1σ², where ŵₖ is dual uplink receiver beamforming, F is linear system matrix for solving δ, 1 is an all-one vector, σ is a noise power, and δ is a matrix of δₖ's.

In an embodiment, disclosed herein is a downlink multicell cooperation model in which BSs are connected to a central processor (CP) or a central cloud processor (CCP) via rate-limited backhaul links. The links may be wired and/or wireless links. A user centric clustering model is disclosed where each scheduled user is cooperatively served by a cluster of BSs, and the serving BSs for different users may overlap. Disclosed is a formulation of an optimal joint clustering and beamforming design problem in which each user dynamically forms a sparse network-wide beamforming vector whose non-zero entries correspond to the serving BSs. Specifically, a fixed signal-to-interference-and-noise ratio (SINR) constraint for each user is assumed and a method for an optimal tradeoff between the sum transmit power and the sum backhaul capacity needed to form the cooperating clusters is disclosed. Intuitively, larger cooperation size leads to lower transmit power, because interference can be mitigated through cooperation, but it also leads to higher sum backhaul, because user data needs to be made available to more BSs. In an embodiment, a sparse beamforming problem is formulated as an l₀-norm optimization problem and then an iterative reweighted l₁ heuristic is utilized to find a solution. A key observation of an embodiment of this disclosure is that the reweighting can be done on the l₂-norm square of the beamformers (i.e., the power) at the BSs. This gives rise to a weighted power minimization problem over the entire network, which can be solved using the uplink-downlink duality technique with low computational complexity. Embodiment methods and systems provide a better tradeoff between the sum power and the sum backhaul capacity in the high SINR regime than do previous solutions.

For fixed user data rates, one issue is determining the optimal tradeoff between total transmit power and sum backhaul capacity over all BSs. The more backhaul capacity one has, the more BSs can collaborate to form a larger cluster for a particular user, and hence the less transmit power one would need to serve the user for a fixed data rate because the intercell interference can be efficiently mitigated through cooperation between BSs within the cluster. However, to find the optimal tradeoff between transmit power and backhaul capacity mathematically is nontrivial due to the discrete nature of backhaul connections.

In line with compressive sensing, an embodiment approximates the backhaul rate into a weighted l₂-norm square fashion, which allows the problem to be formulated into a weighted power minimization problem with signal plus interference to noise ratio (SINR) constraints. By properly updating the weights iteratively, a sparse beamforming vector can be found for every user in the system, where the entries corresponding to the BSs that do not serve the user will be zero in the limit.

One aspect of an embodiment is that by relaxing the backhaul rate into a weighted l₂-norm square term, the resulting algorithm admits a semi-closed form solution, but performs better than other algorithms in a high SINR regime. An embodiment jointly designs BS clustering and beamforming for fixed user rates by adopting a reweighted f₂-norm square approximation of the backhaul rate. An embodiment finds a tradeoff between sum power and sum backhaul under fixed user rates, and optimizes backhaul capacity. An embodiment chooses weights in reweighted optimization to optimize the tradeoff. Further, an embodiment designs beamformers, selects BS cluster and allocates power jointly under fixed user scheduling and user rates.

The embodiments are described below primarily with reference to networks that include base stations. However, the disclosed systems and methods are not limited to base stations. In various embodiments, the one or more of the base stations in each embodiment may be replaced with any type of transmission point, such as, for example, wireless access points (APs), micro-base-stations, pico-base-stations, transceiver stations (BTSs), an enhanced base station (eNB), a femtocell, and other similar devices.

I. Sparse Beamforming Design for Network MIMO System with Per-Base-Station Power Constraints and Per-Base-Station Backhaul Constraints for Maximizing Utility

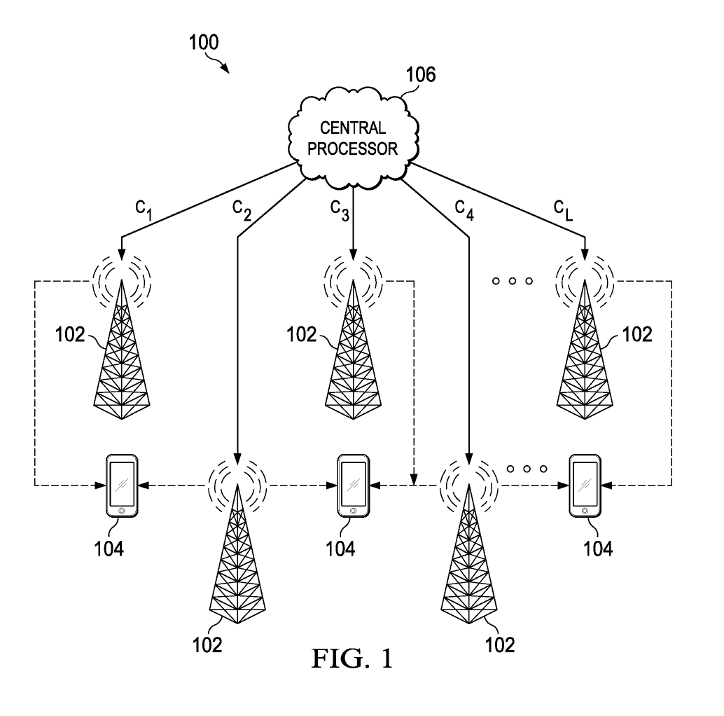

FIG. 1 is a schematic diagram of an embodiment network MIMO system 100 with per-BWS backhaul constraints. System 100 is a multicell cooperation system with L BS's 102 and K users 104 in total, where each BS 102 has M transmit antennas while each user 104 has single receive antenna and is served coordinately by a potentially overlapped subset of BS's 102. The BS's 102 are connected to a CP 106 via limited backhaul links with a total capacity constraint Cl,l=1, 2, . . . , L, and the CP 106 has access to all channel state information (CSI) and user data.

Consider a downlink (DL) multiple-input single-output (MISO) system with BSs 102 connected to a CP 106 or central cloud via a limited backhaul, where the CP 106 or cloud has access to all the CSI and data for all users in the system. Each user 104 selects a cluster of multiple BSs 102, which coordinately transmit data to that user 104.

Alternatively consider a downlink Network MIMO system with L BSs connected to a central cloud via a limited backhaul, where the cloud has access to all the CSI and signals for all users in the system. Each BS has M antennas while each user has a single antenna. Each user has a cluster of multiple BSs that coordinately transmit data to the user.

For both considerations above, a larger cluster results in a higher user data rate at fixed transmit power or a lower transmit power at fixed user data. However, the larger cluster also results in a higher backhaul rate because the user's data is made available at a larger set of BSs.

With a linear transmit beamforming scheme, the received signal at user k, denoted as

$${y}_{k} = {H}_{k} {w}_{k} {s}_{k} + {\sum }_{j \neq k} {H}_{k} {w}_{j} {s}_{j} + {n}_{k} , \qquad ( 1 \text{-} 1 )$$

where Hₖε [symbol] ^{N×M}^{ₜ} and wₖε [symbol] ^{M}^{ₜ}^{×1}=[wₖ¹, wₖ², . . . , wₖ^{L}] denote the CSI matrix and beamforming vector respectively from all the Mₜ=LM transmit antennas to user k. In an embodiment, to simplify the notations, it is assumed that all the L BSs 102 can potentially serve each scheduled user 104. However, in an embodiment, only the strongest few BSs 102 around each user 104 are considered as the candidate serving BSs 102 to reduce computational complexity. Suppose BS l is not part of user k's serving cluster, then the corresponding beamforming entries wₖε [symbol] ^{M}^{ₜ}^{×1} are set to 0. For ease of explanation, the case where each user has only a single data stream is considered for simplicity and it is assumed that user k's message sₖε [symbol] is independent and identically distributed according to [symbol] (0,1). Here, nₖε [symbol] ^{N×1} is the received noise at user k and modeled as nₖ˜ [symbol] (0,σ² I).

In an embodiment, it is assumed that the CP 106 has access to all the users' 104 data and has the global CSI for designing the optimal sparse beamforming vector wₖ for each user k. Once wₖ is determined, the CP 106 transmits user k's 104 message, along with the beamforming coefficients, to those BSs 102 corresponding to the nonzero entries in wₖ through the backhaul links. In an embodiment, only the backhaul consumption due to the user data sharing is considered and the backhaul required for delivering beamforming coefficients is ignored. Under these conditions, the per-BS backhaul constraint can be cast as

$${\sum }_{k} {‖ {‖ {w}_{k}^{l} ‖}_{2}^{2} ‖}_{0} {R}_{k} \leq {C}_{l} , ∀ l \qquad ( 1 \text{-} 2 )$$

where Rₖ is the achievable rate for user k defined as

$${R}_{k} = log ( 1 + {w}_{k}^{H} {{H}_{k}^{H} ( {\sum }_{j \neq k} {H}_{k} {w}_{j} {w}_{j}^{H} {H}_{k}^{H} + {σ}^{2} I )}^{- 1} {H}_{k} {w}_{k} ) \qquad ( 1 \text{-} 3 )$$

where the superscript H denotes the Hermitian Transpose operation in the matrix computation field wₖ^{H}Hₖ^{H} and Hₖwⱼ are operating on the same arguments. In other words, Hₖwⱼ is the product of Hₖ and wⱼ while wₖ^{H}Hₖ^{H} is the product of the Hermitian Transpose of Hₖ and wⱼ. Intuitively, the backhaul consumption at the lth BS 102 is the accumulated data rates of the users 104 served by BS l 102. Here, ∥||wₖ^{l}||₂²∥₀ characterizes whether or not BS l 102 serves user k 104, i.e.,

$${‖ {‖ {w}_{k}^{l} ‖}_{2}^{2} ‖}_{0} = \{ \begin{matrix}0 , & if {‖ {w}_{k}^{l} ‖}_{2}^{2} = 0 \\ 1 , & otherwise\end{matrix} . \qquad ( 1 \text{-} 4 )$$

In an embodiment, disclosed herein is a network maximization system and method. Further disclosed herein is a network maximization system and method utilizing the WSR utility. However, the disclosed methods and systems may be applied to any utility function that holds an equivalence relationship with the WMMSE minimization problem.

With per-BS power constraints and per-BS backhaul constraints, the WSR maximization problem can be formulated as:

$$\begin{matrix}\begin{matrix}maximize \\ \{ {w}_{k}^{l} \}\end{matrix} {\sum }_{k} {α}_{k} {R}_{k} & ( 1 \text{-} 5 a ) \\ subject to {\sum }_{k} {‖ {w}_{k}^{l} ‖}_{2}^{2} \leq {P}_{l} , ∀ l & ( 1 \text{-} 5 b ) \\ {\sum }_{k} {‖ {‖ {w}_{k}^{l} ‖}_{2}^{2} ‖}_{0} {R}_{k} \leq {C}_{l} , ∀ l & ( 1 \text{-} 5 c )\end{matrix}$$

where αₖ denotes the priority weight associated with user k, Pₗ and Cₗ represent the transmit power budget and backhaul capacity limit for BS l, respectively.

The conventional WSR maximization problem is a well-known nonconvex problem, for which finding the global optimality is already quite challenging even without the additional backhaul constraint. In an embodiment, disclosed here are methods and systems that focus on solving for the local optimum solution of the problem (1-5) only. One disclosed aspect of embodiment methods and systems is a method for dealing with the discrete lₒ-norm constraint (1-5c).

In compressive sensing literature, the nonconvex lₒ-norm objective is often approximated by the convex reweighted l₁-norm. Disclosed herein is a method to extend this idea to the lₒ-norm in the constraint and approximate (1-5c) as

$${\sum }_{k} {β}_{k}^{l} {R}_{k} {‖ {w}_{k}^{l} ‖}_{2}^{2} \leq {C}_{l} \qquad ( 1 \text{-} 6 )$$

where βₖ^{l} is a constant weight associated with BS l and user k and is updated iteratively according to

$${β}_{k}^{l} = \frac{1}{{‖ {w}_{k}^{l} ‖}_{2}^{2} + τ} , ∀ k , l \qquad ( 1 \text{-} 7 )$$

with some small constant regularization factor τ>0 and ∥wₖ^{l}∥₂² from the previous iteration.

Even with the above approximation, the optimization problem (1-5) with the backhaul constraint (1-5c) replaced by (1-6) is still difficult to deal with due to the fact that the rate Rₖ in the constraint is unknown. To address this difficulty, problem (1-5) is solved iteratively with fixed rate \hat{R}ₖ in (1-6) and \hat{R}ₖ is updated by the achievable rate Rₖ from the previous iteration. The fixed rate \hat{R}ₖ is the transmission rate from the BS to the UE for user k. Under fixed βₖ^{l} and \hat{R}ₖ, problem (1-5) now reduces to

$$\begin{matrix}\begin{matrix}maximize \\ \{ {w}_{k}^{l} \}\end{matrix} {\sum }_{k} {α}_{k} {R}_{k} & ( 1 \text{-} 8 a ) \\ subject to {\sum }_{k} {‖ {w}_{k}^{l} ‖}_{2}^{2} \leq {P}_{l} , ∀ l & ( 1 \text{-} 8 b ) \\ {\sum }_{k} {β}_{k}^{l} {\hat{R}}_{k} {‖ {w}_{k}^{l} ‖}_{2}^{2} \leq {C}_{l} , ∀ l & ( 1 \text{-} 8 c )\end{matrix}$$

where the approximated backhaul constraint (1-8c) can be interpreted as a weighted per-BS power constraint bearing a resemblance to the traditional per-BS power constraint (1-8b). Although the approximated problem (1-8) is still nonconvex, it can be reformulated as an equivalent WMMSE minimization problem in order to reach a local optimum solution. The equivalence between WSR maximization and WMMSE minimization has been shown. The generalized WMMSE equivalence can be extended to the problem (1-8) with a weighted per-BS power constraint (1-8c). The equivalence can be explicitly stated as follows.

The WSR maximization problem (1-8) has the same optimal solution with the following WMMSE minimization problem:

$$\begin{matrix}minimize \\ \{ {ρ}_{k} , {u}_{k} , {w}_{k}^{l} \}\end{matrix} {\sum }_{k} {α}_{k} ( {ρ}_{k} {e}_{k} - log {ρ}_{k} ) \\ subject to {\sum }_{k} {‖ {w}_{k}^{l} ‖}_{2}^{2} \leq {P}_{l} , ∀ l \\ {\sum }_{k} {β}_{k}^{l} {\hat{R}}_{k} {‖ {w}_{k}^{l} ‖}_{2}^{2} \leq {C}_{l} , ∀ l \qquad ( 1 \text{-} 9 )$$

where ρₖ denotes the Mean Square Error (MSE) weight for user k and eₖ is the corresponding MSE defined as

$${e}_{k} = E [ {‖ {u}_{k}^{H} {y}_{k} - {s}_{k} ‖}_{2}^{2} ] = {u}_{k}^{H} ( {\sum }_{j} {H}_{k} {w}_{j} {w}_{j}^{H} {H}_{k}^{H} + {σ}^{2} I ) {u}_{k} - 2 Re \{ {u}_{k}^{H} {H}_{k} {w}_{k} \} + 1 \qquad ( 1 \text{-} 10 )$$

under receiver uₖε [symbol] ^{N×1}.

One advantage of solving the WSR minimization problem (1-8) through its equivalent WMMSE minimization problem (1-9) is that (1-9) is convex with respect to each of the individual optimization variables. This observation allows the problem (1-9) to be solved efficiently through the block coordinate descent method by iterating between ρₖ, uₖ, and wₖ:
The optimal MSE weight ρₖ under fixed uₖ, and wₖ is given by

ρₖ=eₖ⁻¹,∀k. (1-11)
The optimal receiver uₖ under fixed wₖ and ρₖ is the MMSE receiver:

$${u}_{k} = {( {\sum }_{j} {H}_{k} {w}_{j} {w}_{j}^{H} + {σ}^{2} I )}^{- 1} {H}_{k} {w}_{k} , ∀ k . \qquad ( 1 \text{-} 12 )$$

The optimization problem to find the optimal transmit beamformer wₖ under fixed uₖ and ρₖ is a quadratically constrained quadratic programming (QCQP) problem, which can be solved using standard convex optimization solvers such as CVX. uₖ is the receiver beamformer at user k side.

A straightforward but computationally intensive method of applying the above WMMSE method to solve the original problem (1-5) involves two loops: an inner loop to solve the approximated WSR maximization problem (1-8) with fixed weight βₖ^{l} and rate \hat{R}ₖ, and an outer loop to update βₖ^{l} and \hat{R}ₖ. However, in an embodiment, the two loops are combined into a single loop and the weight βₖ^{l} and rate \hat{R}ₖ are updated inside of the WMMSE approach, as summarized in the Method 1 below.

Method 1 has the same complexity order as the conventional WMMSE approach since it only introduces two additional steps 4 and 5 in each iteration in updating βₖ^{l} and \hat{R}ₖ, which are both closed-form functions of the transmit beamformers. The additional computational complexity of Method 1 mainly comes from the optimal transmit beamformer design in step 3, which is a QCQP problem as mentioned above, but can also be equivalently reformulated as a second order cone programming (SOCP) problem. The complexity of solving a SOCP using interior-point method is approximately O((KLM)³).

Method 1 Sparse Beamforming Design with Explicit Per-BS Backhaul Constraints

Initialization: βₖ^{l}, \hat{R}ₖ, wₖ, ∀l, k;

Repeat:
1) Fix wₖ, ∀k, compute the MMSE receiver uₖ and the corresponding MSE eₖ according to (1-12) and (1-10);
2) Update the MSE weight ρₖ according to (1-11) or according to ρₖ=αₖ/eₖ, ∀k;
3) Find the optimal transmit beamformer wₖ under fixed uₖ and ρₖ, ∀k.
4) Compute the achievable rate Rₖ according to (1-3), ∀k;
5) Update \hat{R}ₖ=Rₖ and βₖ^{l} according to (1-7), ∀l, k.

Until convergence

Although described herein primarily with the use of WMMSE algorithms for utility maximization, those of ordinary skill in the art will recognize that the WMMSE algorithm is but one method for solving the weighted sum rate maximization problem and that in other embodiments, other methods for beamforming design for maximizing weighted sum rate can be used.

To improve the efficiency of the disclosed Method 1 in each iteration, in what follows, are two techniques, iterative link removal and iterative user pool shrinking. The former aims at reducing the number of potential transmit antennas LM serving each user while the latter is intended to decrease the total number of users K to be considered in each iteration.

A. Iterative Link Removal

In embodiments, the transmit power from some of the candidate serving BS s drops down rapidly close to zero as the iterations proceed. By taking advantage of this, disclosed is a method to iteratively remove the lth BS from the kth user's candidate cluster once the transmit power from BS l to user k, i.e., ∥wₖ^{l}∥₂², is below a certain threshold, e.g., −100 dBm/Hz. This reduces the dimension of the potential transmit beamformer for each user and reduces the complexity of solving SOCP in Step 3 of Method 1.

B. Iterative User Pool Shrinking

The WMMSE method does user scheduling implicitly. It may be beneficial for Method 1 to consider a large pool of users in the iterative process. However, to consider all the users in the entire network all the time would incur significant computational burden. Instead, in an embodiment, the achievable user rate Rₖ in Step 4 of Method 1 is checked iteratively and those users with negligible rates (e.g., below some threshold, say 0.01 bps/Hz) are ignored during the next iteration. In an embodiment, after around 10 iterations, more than half of the total users can be taken out of the consideration with negligible performance loss to the overall method. This significantly reduces the total number of variables to be optimized during the subsequent iterations.

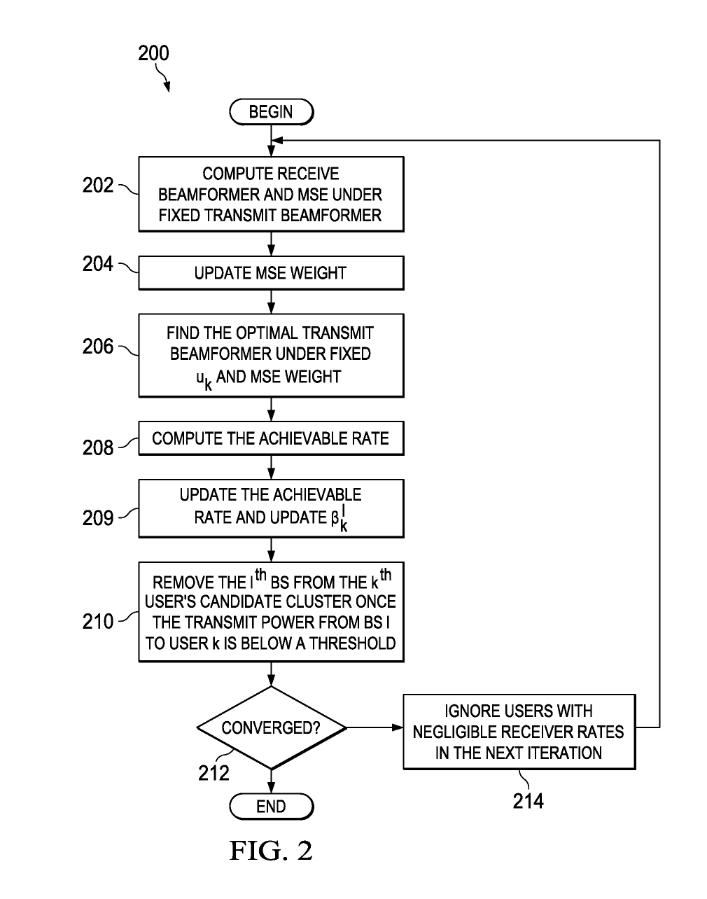

FIG. 2 illustrates a flow diagram for an embodiment method 200 for sparse beamforming for maximizing network utility for variable-rate applications under radio resource limits. Method 200 begins at block 202 where the central processor computes the receive beamformer and the MSE under a fixed transmit beamformer. At block 204, the central processor updates the MSE weight. At block 206, the central processor finds the optimal transmit beamformer under fixed uₖ and MSE weight. At block 208, the central processor computes the achievable rate. At block 209, the central processor updates the achievable transmit rate, \hat{R}ₖ, to be \hat{R}ₖ=Rₖ and updates βₖ^{l} according to (1-7). At block 210, the central processor removes the lth BS from the kth user's candidate cluster if the transmit power from BS l to user k is below a threshold. At block 212, the central processor determines whether the receive beamformer has converged. As used herein, in some embodiments, the term converged means that successive iterations produce the same result or do not differ from a previous iteration by more than some pre-determined amount or percentage. If, at block 212, the receive beamformer has converged, then the method 200 ends. If, at block 212, the central processor determines that the receive beamformer has not converged, then the method 200 proceeds to block 214 where the central processor determines which users have negligible receiver rates and ignores these users in the next iteration which commences at block 202.

II. Sparse Beamforming for Limited-Backhaul Network MIMO System Via Reweighted Power Minimization

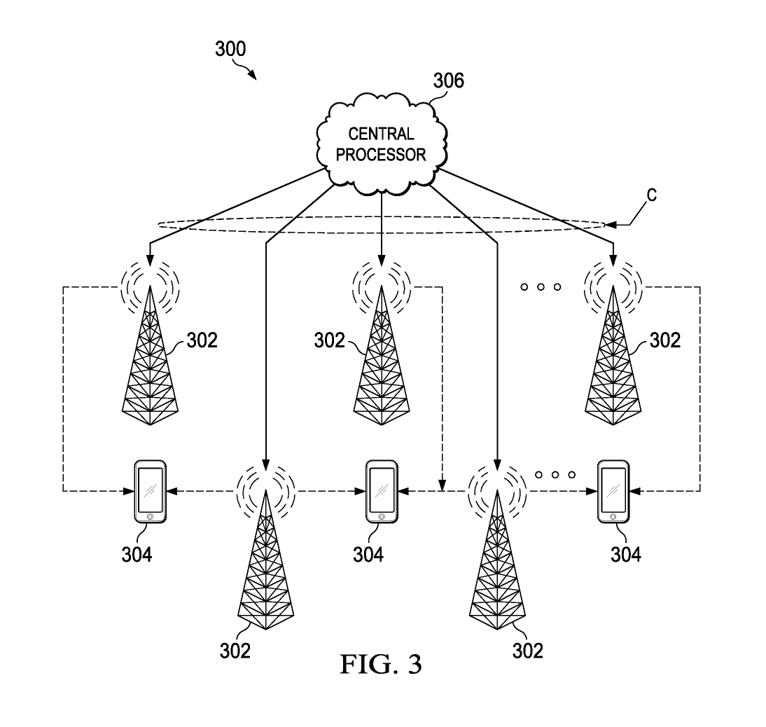

FIG. 3 is a schematic diagram of an embodiment network 300 for downlink multicell cooperation system. Network 300 is an embodiment system of BSs 302 connected to a central cloud processor (CCP) 306 via a limited backhaul. In an embodiment, network 300 is a MIMO system. Network 300 includes a plurality of BSs 302, a plurality of users 304, and a CCP 306. All the BSs 302 are connected to the CCP 306 via limited backhaul links under a total capacity limit C, where each scheduled user 304 is cooperatively served by a potentially overlapping subset of BSs 302. In an embodiment, consider that the network 300 MIMO system includes L BSs 302 connected to the CCP 306 via limited backhaul links and suppose that there are K single antenna users 304. In an embodiment, the CCP 306 has access to all user 304 data and CSI in the system. Although, a fully cooperative network MIMO system, where every single user 304 is served by all the L BS's 302, can dramatically reduce the intercell interference, it also requires very high backhaul capacity, because the CCP 306 needs to make every user's data available at every BS 302. Disclosed herein is a more practical architecture in which each user 304 selects only a subset of serving BS's 302 (which are potentially overlapping) and the CCP 306 only distributes the user's data to that user's serving BSs 302.

Assuming that each user operates at a fixed data rate, an embodiment provides a low-complexity algorithm to find the optimal tradeoff between total transmit power and sum backhaul demand over all BSs. An embodiment system and method provide sparse beamforming design via reweighted power.

Let wₖε [symbol] ^{ML×1}=[wₖ¹, wₖ², . . . , wₖ^{L}] be the transmit beamformer over all BSs 302 for user k, where wₖ^{l}ε [symbol] ^{ML×1} is the transmit beamformer from BS l (l=1, 2, . . . , L) to user k (k=1, 2, . . . , K). Note that wₖ^{l}=0 if BS l is not part of user k's serving cluster. The received signal yₖε [symbol] at user k can be written as:

$${y}_{k} = {h}_{k}^{H} {w}_{k} {s}_{k} + {{\sum }_{j \neq k}}^{K} {h}_{k}^{H} {w}_{j} {s}_{j} + {n}_{k} \qquad ( 2 \text{-} 1 )$$

where hₖε [symbol] ^{ML×1} denotes the CSI vector from all the BSs to user k, sₖ˜ [symbol] (0,σ²) and nₖ˜ [symbol] (0,σ²) are the intended signal and the receiver noise for user k, respectively.

The SINR for user k can be expressed as:

$${SINR}_{k} = \frac{{\vert {h}_{k}^{H} {w}_{k} \vert}^{2}}{{\sum }_{j \neq k} {\vert {h}_{k}^{H} {w}_{j} \vert}^{2} + {σ}^{2}} \qquad ( 2 \text{-} 2 )$$

The achievable rate for user k is then

Rₖ=log(1+SINRₖ) (2-3)

Since each user's data only needs to be made available at its serving BSs, the sum backhaul capacity consumption Cₖ needed for serving user k can be represented as

Cₖ=∥[∥wₖ¹∥₂,∥wₖ²∥₂, . . . ,∥wₖ^{L}∥₂]∥₀Rₖ (2-4)

where ∥Ψ∥₀ denotes the l₀-norm of a vector, i.e., the number of nonzero entries in the vector.

An optimization problem that relates various network resources and the system throughput is now formulated. The network resources considered in this disclosure include the backhaul capacities and the transmit powers at the BSs 302. Clearly, more resources lead to a higher throughput. However, at a fixed user throughput, there is also a tradeoff between the backhaul capacity and the transmit power. Intuitively, higher backhaul capacity allows for more BSs 302 to cooperate, which leads to less interference; hence less transmit power is needed to achieve a target user rate.

In an embodiment, disclosed herein is a method that formulates the tradeoff between the total transmit power and the sum backhaul capacity over all BSs under a fixed user data rates as the following optimization problem:

$$\begin{matrix}minimize \\ {w}_{k}^{l}\end{matrix} {\sum }_{k} {‖ [ {‖ {w}_{k}^{1} ‖}_{2} , ‖ {w}_{k}^{2} ‖ , … , {‖ {w}_{k}^{L} ‖}_{2} ] ‖}_{0} {R}_{k} + η {\sum }_{k} {\sum }_{l} {‖ {w}_{k}^{l} ‖}_{2}^{2} \\ subject to {SINR}_{k} \geq {γ}_{k} , ∀ k \qquad ( 2 \text{-} 5 )$$

where η≧0 is a constant indicating the tradeoff between sum backhaul capacity and sum power, γₖ is the SINR target for user k and Rₖ=log(1+γₖ). One focus of this section of the disclosure is on the numerical solution to this problem.

It is noted that the above problem formulation is not the only possibility here. For example, other formulations study the tradeoff between the user rates and the cluster size in a weighted sum rate maximization problem under fixed power constraints. As a further note, in an embodiment, this section of the disclosure considers the sum power and sum backhaul capacity only, but in practice, the per-BS transmit power and the per-BS backhaul capacity may also be of interest.

Sparse Beamforming Design Methods

The optimization problem (2-5) is nonconvex due to the lₒ-norm representation of the backhaul rate. Finding the global optimal solution to (2-5) is difficult. In an embodiment, problem (2-5) is solved heuristically by iteratively relaxing the lₒ-norm as a weighted l₁-norm.

A. Method with Reweighted Power Minimization

First, observe that if the l₂-norm in (2-4) is replaced by l₂-norm square, the overall l₀-norm remains the same. Thus, the backhaul consumption Cₖ can also be written as

Cₖ=∥[∥wₖ¹∥₂²,∥wₖ²∥₂², . . . ,∥wₖ^{L}∥₂²]∥₀Rₖ (2-6)

The basic idea of l₁-heuristics in compressive sensing is to replace the ∥•∥₀ norm by ∥•∥₁ norm in the optimization problem. Applying this idea to (2-6) and further introducing the appropriate weights, Cₖ can now be approximated as the weighted l₂-norm square of the beamformers, and the problem (5) can now be relaxed as:

$$\begin{matrix}minimize \\ {w}_{k}^{l}\end{matrix} {\sum }_{k} ( {\sum }_{k} {ρ}_{k}^{l} {‖ {w}_{k}^{l} ‖}_{2}^{2} ) {R}_{k} + η {\sum }_{k} {\sum }_{l} {‖ {w}_{k}^{l} ‖}_{2}^{2} \\ subject to {SINR}_{k} \geq {γ}_{k} , ∀ k \qquad ( 2 \text{-} 7 )$$

where ρₖ^{l} is the weight associated with BS l and user k, and where η represents the tradeoff factor between backhaul rates and the transmit powers.

Observe that the problem (2-7) can be further rearranged into the following form:

$$\begin{matrix}minimize \\ {w}_{k}^{l}\end{matrix} {\sum }_{k , l} {α}_{k}^{l} {‖ {w}_{k}^{l} ‖}_{2}^{2} subject to {SINR}_{k} \geq {γ}_{k} , ∀ k \qquad ( 2 \text{-} 8 )$$

where αₖ^{l}=ρₖ^{l} Rₖ+η. Since the l₂-norm square of the beamforming vectors are just the transmit powers at the BSs 302, the above optimization problem is just a weighted power minimization problem.

The weighted power minimization problem (2-8) can be solved efficiently using the well-known uplink-downlink duality approach. One key observation is that this particular relaxation of Cₖ as a weighted l₂-norm square results in a problem formulation whose structure can be efficiently exploited by numerical methods.

Uplink-downlink duality for weighted power minimization has been developed for single cell cases and generalized to multicell settings. Disclosed herein is a method of applying duality to the case where the weight associated with each BS-user pair may be different.

Note that the solution to (2-8) for a fixed weight ρₖ^{l} does not necessarily provide sufficient sparsity. However, by iteratively updating the weights ρₖ^{l} and by solving problem (2-8) repeatedly with updated ρₖ^{l}, a sparse network-wide beamforming vector for each user is eventually obtained, where entries corresponding to the BS s outside of the optimal serving cluster go to zero in the limit. In an embodiment, the following reweighting function to update ρₖ^{l} is adopted:

$${ρ}_{k}^{l} = \frac{1}{{‖ {w}_{k}^{l} ‖}_{2}^{2 p} + {ε}^{p}} \qquad ( 2 \text{-} 9 )$$

where p is some positive exponent and ε is adaptively chosen to be ε=max {(minₖ∥wₖ²∥₂²),τ} and τ is some small positive value, and wₖ^{l}, is the beamforming vector from the previous iteration. It can be shown numerically that with the properly chosen p, the reweighting function (2-9) improves upon the performance of previous methods. Although the system resource minimization problem has been described herein primarily with reference to the above method for selecting ρ, those of ordinary skill in the art will recognize that, in other embodiments, other methods for selecting the weights, ρ, to induce sparsity can also be used.

In an embodiment, to completely characterize the disclosed method, the solution to (2-8) is given based on the following generalization of uplink-downlink duality:

Proposition: The downlink weighted power minimization problem (2-8) is equivalent to the following uplink sum power minimization problem in the sense that they have the same optimal solution up to a scalar factor, i.e., wₖ=\sqrt{δₖ}ŵₖ, ∀k:

$$\begin{matrix}minimize \\ {λ}_{k} , {\hat{w}}_{k}\end{matrix} {\sum }_{k} {λ}_{k} subject to \frac{{λ}_{k} {\vert {\hat{w}}_{k}^{H} {h}_{k} \vert}^{2}}{{\sum }_{j \neq k} {λ}_{j} {\vert {\hat{w}}_{k}^{H} {h}_{j} \vert}^{2} + {w}_{k}^{H} {B}_{k} {\hat{w}}_{k}} \geq {γ}_{k} \qquad ( 2 \text{-} 10 )$$

where ŵₖε [symbol] ^{ML×1} can be interpreted as the receiver beamforming of the dual uplink channel and λₖ≧0 has the interpretation of dual uplink power, which is also the Lagrangian dual variable associated with the SINR constraint in (2-8), and Bₖ is the dual uplink noise covariance matrix defined as Bₖ=diag{αₖ¹Iₘ, αₖ²Iₘ, . . . , αₖ^{L}Iₘ}, ∀k.

The optimal solution to (2-10) is the MMSE receiver, which can be readily written as:

$${\hat{w}}_{k} = {( {\sum }_{j} {λ}_{j} {h}_{j} {h}_{j}^{H} + {B}_{k} )}^{- 1} {h}_{k} \qquad ( 2 \text{-} 11 )$$

where the dual variable λⱼ is to be determined. In an embodiment, in addition, to find the optimal solution wₖ to problem (2-8), it is necessary to find the scalar δⱼ relating to ŵₖ and wₖ. Note that it is easy to see that the SINR constraints in both (2-8) and (2-10) must be achieved with equality at the optimal point. This observation provides a way to find λⱼ and δⱼ.

Substituting (2-11) into the SINR constraint in problem (2-10) with equality, the following is obtained:

$${λ}_{k} = \frac{{γ}_{k}}{{{h}_{k}^{H} ( {\sum }_{j \neq k} {λ}_{j} {h}_{j} {h}_{j}^{H} + {B}_{k} )}^{- 1} {h}_{k}} \qquad ( 2 \text{-} 12 )$$

where we use the fact that ŵₖ in (2-11) is collinear with the vector (Σ_{j≠k}λⱼhⱼhⱼ^{H}+Bₖ)⁻¹hₖ, which can be easily verified by matrix inversion lemma. The expression in (2-12) implies that λₖ can be found numerically by a fixed-point method, whose convergence is guaranteed by the fact that the function in (2-12) is a standard function.

Now, by substituting wₖ=\sqrt{δₖ}ŵₖ into the SINR constraint in (2-8) with equality, K linear equations with K unknowns δₖ, k=1, 2, . . . , K are obtained such that:

$$\frac{1}{{γ}_{k}} {δ}_{k} {\vert {\hat{w}}_{k}^{H} {h}_{k} \vert}^{2} = {\sum }_{j \neq k} {δ}_{j} {\vert {\hat{w}}_{k}^{H} {h}_{j} \vert}^{2} + {σ}^{2} , ∀ k . \qquad ( 2 \text{-} 13 )$$

Therefore, δₖ can be obtained by solving a system of linear equations:

δ=F⁻¹1σ² (2-14)

where δ=[δ₁, δ₂, . . . , δ_{K}], F is defined as:

$${F}_{ii} = \frac{1}{{γ}_{i}} {\vert {\hat{w}}_{i}^{H} {h}_{i} \vert}^{2} ,$$

and Fᵢⱼ=−|ŵⱼ^{H}hᵢ|² for i≠j, and 1 denotes the all-one vector.

An embodiment of the disclosed method is as follows:

Method 2 Sparse Beamforming Design
Fix the tradeoff scalar n:
Initialization: ρₖ^{l}=1 ∀l, k;
Repeat:
   1) Find the optimal dual variable λₖ according to (2-12) using a fixed-point method;
   2) Compute the optimal dual uplink receiver beamforming ŵₖ∀k according to (2-11);
   3) Update wₖ=\sqrt{δₖ}ŵₖ, ∀k with δₖ found by (2-14).
   4) Update ρₖ^{l} according to (2-9).
Until convergence
To find a different tradeoff point between total transmit power and sum backhaul, change η and repeat the above steps.

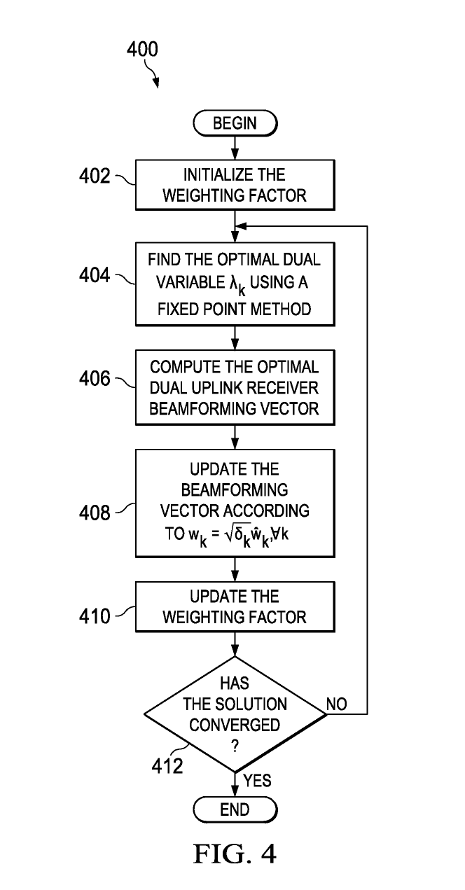

FIG. 4 illustrates a flow diagram for an embodiment method 400 for sparse beamforming with a limited backhaul via reweighted power. The method 400 begins at block 402 where, for fixed trade-off constant between sum power and sum backhaul capacity, the central cloud first initializes the weight, ρₖ^{l} associated with every BS-User pair. In an embodiment, ρₖ^{l}=1 ∀l. At block 404, given the weight, the central cloud computes the optimal dual variable λₖ using a fixed-point method. In an embodiment, λₖ is computed according to 2-12. At block 406, the central cloud processor computes the optimal dual uplink receiver beamforming vector, ŵₖ. In an embodiment, ŵₖ is computed according to 2-11. At block 408, the central cloud processor updates the beamforming vector according to wₖ=wₖ=\sqrt{δₖ}ŵₖ, ∀k where, in an embodiment, δₖ is found by (2-14). At block 408, the weighting factor, ρₖ^{l}, is updated. In an embodiment, the weighting factor, ρₖ^{l} is updated according to (2-9). At block 412, the central cloud processor determines whether the solution has converged. If, at block 412, the solution has not converged, the method 400 proceeds to block 404. If, at bloc 412, the solution has converged, then the method 400 ends.

This embodiment method is computationally efficient because the metric is a weighted sum power minimization problem, which has a semi-closed form solution and can be solved efficiently using uplink-downlink duality together with a fixed point method for power update. An embodiment can be used to efficiently find the tradeoff between the total transmit power and the required backhaul (under a fixed data rate) for a network MIMO system. Although the system resource minimization problem has been described herein primarily with reference to the uplink-downlink duality based method for finding beamformers, those of ordinary skill in the art will recognize that, in other embodiments, other methods for beamforming design can also be used.

An embodiment solution dynamically decides which links should be maintained. An embodiment solution uses generalized reweighted power minimization. An embodiment solution is computationally efficient and achieves a better tradeoff between total transmit power and sum backhaul capacity than previous methods. Embodiments may be implemented in any wireless access system with joint transmission (JT) and a centralized cloud. Embodiments may be implemented in any cloud radio access network (CRAN) access system using joint transmission, which may include the 5G/LTE-B standard.

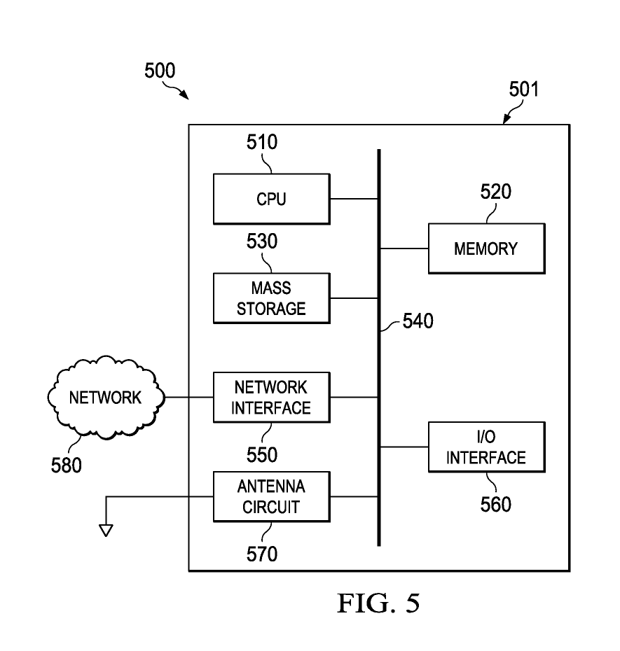

FIG. 5 is a block diagram of a processing system 500 that may be used for implementing the devices and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 500 may comprise a processing unit 501 equipped with one or more input/output devices, such as a speaker, microphone, mouse, touchscreen, keypad, keyboard, printer, display, and the like. The processing unit 501 may include a central processing unit (CPU) 510, memory 520, a mass storage device 530, a network interface 550, an I/O interface 560, and an antenna circuit 570 connected to a bus 540. The processing unit 501 also includes an antenna element 575 connected to the antenna circuit.

The bus 540 may be one or more of any type of several bus architectures including a memory bus or memory controller, a peripheral bus, video bus, or the like. The CPU 510 may comprise any type of electronic data processor. The memory 520 may comprise any type of system memory such as static random access memory (SRAM), dynamic random access memory (DRAM), synchronous DRAM (SDRAM), read-only memory (ROM), a combination thereof, or the like. In an embodiment, the memory 520 may include ROM for use at boot-up, and DRAM for program and data storage for use while executing programs.

The mass storage device 530 may comprise any type of storage device configured to store data, programs, and other information and to make the data, programs, and other information accessible via the bus 540. The mass storage device 530 may comprise, for example, one or more of a solid state drive, hard disk drive, a magnetic disk drive, an optical disk drive, or the like.

The I/O interface 560 may provide interfaces to couple external input and output devices to the processing unit 501. The I/O interface 560 may include a video adapter. Examples of input and output devices may include a display coupled to the video adapter and a mouse/keyboard/printer coupled to the I/O interface. Other devices may be coupled to the processing unit 501 and additional or fewer interface cards may be utilized. For example, a serial interface such as Universal Serial Bus (USB) (not shown) may be used to provide an interface for a printer.

The antenna circuit 570 and antenna element 575 may allow the processing unit 501 to communicate with remote units via a network. In an embodiment, the antenna circuit 570 and antenna element 575 provide access to a wireless wide area network (WAN) and/or to a cellular network, such as Long Term Evolution (LTE), Code Division Multiple Access (CDMA), Wideband CDMA (WCDMA), and Global System for Mobile Communications (GSM) networks. In some embodiments, the antenna circuit 570 and antenna element 575 may also provide Bluetooth and/or WiFi connection to other devices.

The processing unit 501 may also include one or more network interfaces 550, which may comprise wired links, such as an Ethernet cable or the like, and/or wireless links to access nodes or different networks. The network interface 501 allows the processing unit 501 to communicate with remote units via the networks 580. For example, the network interface 550 may provide wireless communication via one or more transmitters/transmit antennas and one or more receivers/receive antennas. In an embodiment, the processing unit 501 is coupled to a local-area network or a wide-area network for data processing and communications with remote devices, such as other processing units, the Internet, remote storage facilities, or the like.

The following references are related to subject matter of the present application. Each of these references is incorporated herein by reference in its entirety:
[1] D. Gesbert, S. Hanly, H. Huang, S. Shamai Shitz, O. Simeone, and W. Yu, “Multi-cell MIMO cooperative networks: A new look at interference,” IEEE Journal on Selected Areas in Communications, vol. 28, no. 9, pp. 1380-1408, December 2010.
[2] S. Venkatesan, A. Lozano, and R. Valenzuela, “Network MIMO: Overcoming intercell interference in indoor wireless systems,” in Conference Record of the Forty-First Asilomar Conference on Signals, Systems and Computers, November 2007, pp. 83-87.
[3] P. Marsch and G. Fettweis, “On base station cooperation schemes for downlink network MIMO under a constrained backhaul,” in IEEE Global Telecommunications Conference (Globecom), 2008, pp. 1-6.
[4] O. Simeone, O. Somekh, S. Shamai et al., “Downlink multicell processing with limited-backhaul capacity,” EURASIP Journal on Advances in Signal Processing, 2009.
[5] S. Shamai and M. Wigger, “Rate-limited transmitter-cooperation in Wyners asymmetric interference network,” in Proc. IEEE International Symposium on Information Theory (ISIT), 2011.
[6] E. Candes, M. Wakin, and S. Boyd, “Enhancing sparsity by reweighted l1 minimization,” Journal of Fourier Analysis and Applications, vol. 14, no. 5, pp. 877-905, 2008.
[7] J. Gong, S. Zhou, Z. Niu, L. Geng, and M. Zheng, “Joint scheduling and dynamic clustering in downlink cellular networks,” in IEEE Global Telecommunications Conference (Globecom). IEEE, 2011, pp. 1-5.
[8] S. A. Ramprashad, G. Caire, and H. C. Papadopoulos, “A joint scheduling and cell clustering scheme for MU-MIMO downlink with limited coordination,” in 2010 IEEE International Conference on Communications (ICC), 2010, pp. 1-6.
[9] M. Hong, R.-Y. Sun, H. Baligh, and Z.-Q. Luo, “Joint base station clustering beamformer design for partial coordinated transmission in heterogeneous networks,” IEEE Journal on Selected Areas in Communications, vol. 31, no. 2, pp. 226-240, February 2013.
[10] S. Mehryar, A. Chowdhery, and W. Yu, “Dynamic cooperation link selection for network MIMO systems with limited backhaul capacity,” in IEEE International Conference on Communications (ICC), 2012.
[11] C. T. Ng and H. Huang, “Linear precoding in cooperative MIMO cellular networks with limited coordination clusters,” IEEE Journal on Selected Areas in Communications, vol. 28, no. 9, pp. 1446-1454, 2010.
[12] J. Zhao, T. Q. S. Quek, and Z. Lei, “Coordinated multipoint transmission with limited backhaul data transfer,” submitted to IEEE Transactions on Wireless Communications, 2012.
[13] S. Boyd and L. Vandenberghe, Convex optimization. Cambridge University Press, 2004.
[14] H. Dahrouj and W. Yu, “Coordinated beamforming for the multicell multi-antenna wireless system,” IEEE Transactions on Wireless Communications, vol. 9, no. 5, pp. 1748-1759, 2010.
[15] W. Yu and T. Lan, “Transmitter optimization for the multi-antenna downlink with per-antenna power constraints,” IEEE Transactions on Signal Processing, vol. 55, no. 6, pp. 2646-2660, 2007.
[16] T. Kailath, A. H. Sayed, and B. Hassibi, Linear estimation. Prentice Hall N.J., 2000, vol. 1.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of designing sparse transmit beamforming for a network multiple-input multiple output (MIMO) system, the method comprising:
dynamically forming, by a cloud central processor, a cluster of transmission points (TPs) for use in transmit beamforming for each of a plurality of user equipment (UEs) in the system by optimizing a network utility function and system resources;
determining, by the cloud central processor, a sparse beamforming vector for each UE according to the optimizing; and
transmitting, by the cloud central processor, a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

2. The method of claim 1, wherein dynamically and adaptively forming a cluster of TPs comprises one of maximizing a utility function with fixed system resources and minimizing system resources with a given user experience constraint.

3. The method of claim 2, wherein the utility function comprises a weighted sum rate and the system resources comprise transmit power and backhaul rates.

4. The method of claim 1, wherein forming the cluster comprises iteratively optimizing, by the cloud central processor, one of a first function and a second function, wherein iteratively optimizing the first function comprises iteratively minimizing required system resources to support at least one desired user experience constraint, and wherein iteratively optimizing the second function comprises iteratively maximizing a utility function of user transmission rates with pre-specified system resource constraints.

5. The method of claim 4, wherein the system resources comprise transmit power and backhaul rates.

6. The method of claim 4, wherein the utility function is a weighted rate sum of user rates and wherein the pre-specified system resources constraints comprise transmit power constraints and backhaul rate constraints.

7. The method of claim 4, wherein iteratively maximizing a utility function of user transmission rates with pre-specified system resource constraints comprises iteratively performing:
computing a minimum mean square error (MMSE) receiver and a corresponding MSE;
updating an MSE weight;
finding an optimal transmit beamformer under a fixed utility function and MSE weight;
computing an achievable transmission rate for a user equipment, k; and
updating a fixed transmission rate and a fixed weight to be equal to the achievable transmission rate.

8. The method of claim 7, wherein computing the MMSE receiver and the corresponding MSE comprises computing
uₖ=(ΣⱼHₖwⱼwⱼ^{H}Hₖ^{H}+σ²I)⁻¹Hₖwₖ,∀k,
where uₖ is the MMSE receiver, Hₖ is channel state information from all the TPs to user k, wⱼ is the beamforming vector for a j^{th} user equipment, wherein a superscript H denotes a Hermitian Transpose in matrix operation, is a received noise power, and I is an identity matrix and computing
$${e}_{k} = E [ {‖ {u}_{k}^{H} {y}_{k} - {s}_{k} ‖}_{2}^{2} ] = {u}_{k}^{H} ( {\sum }_{j} {H}_{k} {w}_{j} {w}_{j}^{H} {H}_{k}^{H} + {σ}^{2} I ) {u}_{k} - 2 Re \{ {u}_{k}^{H} {H}_{k} {w}_{k} \} + 1$$
where eₖ is the corresponding MSE, E is an expectation operator, uₖ^{H} is the Hermitian Transpose of a receive beamformer for user k, yₖ is a receive signal at user k, and sₖ is intended data for user k.

9. The method of claim 8, wherein ρₖ is the MSE weight and wherein updating the MSE weight comprises computing ρₖ according to ρₖ=eₖ⁻¹.

10. The method of claim 9, wherein the achievable rate is R and wherein computing the achievable rate comprises computing R according to
Rₖ=log(1+wₖ^{H}Hₖ^{H}(Σ_{j≠k}Hₖwⱼwⱼ^{H}Hₖ^{H}+σ²I)⁻¹Hₖwₖ).

11. The method of claim 10, wherein \hat{R}ₖ is the fixed transmission rate and wherein updating the fixed transmission rate and the fixed weight comprises setting \hat{R}ₖ=Rₖ and computing βₖ^{l} according to
$${β}_{k}^{l} = \frac{1}{{‖ {w}_{k}^{l} ‖}_{2}^{2} + τ} , ∀ k , l ,$$
where βₖ^{l} is the fixed weight for wₖ^{l}∥wₖ^{l}∥₂² is a transmit power from TP 1 to user k, and τ is a regularization constant.

12. The method of claim 4, further comprising iteratively removing a TP from the formed cluster once transmit power from the first TP to the associated UE is below a threshold.

13. The method of claim 4, further comprising ignoring a first one of the user equipment when an achievable user transmission rate for the first one of the user equipment is below a threshold.

14. The method of claim 4, wherein iteratively minimizing required system resources comprises minimizing a weighted sum of transmit powers and backhaul rates, and wherein the at least one desired user experience constraint comprises user transmission data rates.

15. The method of claim 4, wherein the optimizing comprises iteratively performing:
minimizing a function of transmission powers and backhaul rates according to:
$$\begin{matrix}minimize \\ {w}_{k}\end{matrix} {\sum }_{k , l} {α}_{k}^{l} {‖ {w}_{k}^{l} ‖}_{2}^{2} subject to {SINR}_{k} \geq {γ}_{k} , ∀ k$$
where αₖ^{l}=ρₖ^{l} Rₖ+η, where ρₖ^{l} is a weight associated with each transmission point-user equipment pair, Rₖ is an effective transmission rate of user k, and η is a scalar;
finding an optimal dual variable using a fixed-point method;
computing an optimal dual uplink receiver beamforming vector;
updating the beam forming vector and δₖ, wherein δₖ is a scaling factor relating uplink optimal receiver beamforming and downlink optimal transmit beamforming; and
updating weights, ρₖ^{l} associated with each transmission point-user equipment pair, according to:
$${ρ}_{k}^{l} = \frac{1}{{‖ {w}_{k}^{l} ‖}_{2}^{2 p} + {ε}^{p}}$$
where p is some positive exponent and ε is adaptively chosen to be ε=max{(min_{k,l}∥wₖ^{l}∥₂²),τ} and τ is some small positive value, and wherein αₖ^{l} is updated according to αₖ^{l}=ρₖ^{l}Rₖ+η, where η represents a tradeoff factor between backhaul rates and transmit powers.

16. The method of claim 15, wherein the optimal dual variable is λₖ for a k^{th} user and finding the optimal dual variable comprises determining λₖ according to:
$${λ}_{k} = \frac{{γ}_{k}}{{{h}_{k}^{H} ( {\sum }_{j \neq k} {λ}_{j} {h}_{j} {h}_{j}^{H} + {B}_{k} )}^{- 1} {h}_{k}} ,$$
where γₖ is SINR target for user k, hₖ^{H} is Hermitian transpose of channel state information vector to user k, hⱼ is channel state information for user j, hⱼ^{H} is Hermitian transpose of channel state information for user j, and Bₖ is dual uplink noise covariance matrix.

17. The method of claim 16, wherein the optimal dual uplink receiver beamforming vector is ŵₖ and computing the optimal dual uplink receiver beamforming vector comprises determining ŵₖ according to:
ŵₖ=(Σⱼλⱼhⱼhⱼ^{H}+Bₖ)⁻¹hₖ.

18. The method of claim 17, wherein the beamforming vector is wₖ, wherein updating the beamforming vector and updating δₖ comprises determining wₖ according to wₖ=\sqrt{δₖ}ŵₖ and determining δₖ according to δ=F⁻¹1σ², where ŵₖ is dual uplink receiver beamforming, F is linear system matrix for solving δ, 1 is an all-one vector, σ is a noise power, and δ is a matrix of δₖ's.

19. A cloud central processor configured to design sparse transmit beamforming for a network multiple-input multiple output (MIMO) system, the cloud central processor comprising:
a processor; and
a computer readable storage medium storing programming for execution by the processor, the programming including instructions to:
dynamically form a cluster of transmission points (TPs) for use in transmit beamforming for each of a plurality of user equipment (UEs) in the system by optimizing a network utility function and system resources;
determine a sparse beamforming vector for each UE according to the optimizing; and
transmit a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

20. The cloud central processor of claim 19, wherein the instructions to dynamically and adaptively form a cluster of TPs comprises one of instructions to maximize a utility function with fixed system resources and instructions to minimize system resources with a given user experience constraint.

21. The cloud central processor of claim 20, wherein the utility function comprises a weighted sum rate and the system resources comprise transmit power and backhaul rates.

22. The cloud central processor of claim 19, wherein the system resources comprise transmit power and backhaul rates.

23. The cloud central processor of claim 19, wherein the utility function is a weighted rate sum of user rates and wherein pre-specified system resources constraints comprise transmit power constraints and backhaul rate constraints.

24. The cloud central processor of claim 19, wherein the instructions to iteratively optimize the utility function comprise instructions to iteratively:
compute a minimum mean square error (MMSE) receiver and a corresponding MSE;
update an MSE weight;
find an optimal transmit beamformer under a fixed utility function and MSE weight;
compute an achievable transmission rate for a user equipment, k; and
update a fixed transmission rate and a fixed weight to be equal to the achievable transmission rate.

25. The cloud central processor of claim 19, further comprising iteratively removing a first one of the transmission points from a user's candidate cluster once transmit power from the first BS to the user is below a threshold.

26. The cloud central processor of claim 19, further comprising ignoring a first one of the user equipment when an achievable user transmission rate for the first one of the user equipment is below a threshold.

27. The cloud central processor of claim 19, wherein iteratively minimizing required system resources comprises minimizing a weighted sum of transmit powers and backhaul rates, and wherein at least one desired user experience constraint comprises user transmission data rates.

28. The cloud central processor of claim 19, wherein the instructions to optimize comprises instructions to iteratively:
minimize a function of transmission powers and backhaul rates according to:
$$\begin{matrix}minimize \\ {w}_{k }^{l}\end{matrix} {\sum }_{k , l} {α}_{k}^{l} {‖ {w}_{k}^{l} ‖}_{2}^{2} subject to {SINR}_{k} \geq {γ}_{k} , ∀ k$$
where αₖ^{l}=ρₖ^{l}Rₖ+η, where ρₖ^{l} is a weight associated with each transmission point-user equipment pair, Rₖ is an effective transmission rate of user k, and η is a scalar;
find an optimal dual variable using a fixed-point method;
compute an optimal dual uplink receiver beamforming vector;
update the beam forming vector and δₖ, wherein δₖ is a scaling factor relating uplink optimal receiver beamforming and downlink optimal transmit beamforming; and
update weights, ρₖ^{l}, associated with each transmission point-user equipment pair, according to:
$${ρ}_{k}^{l} = \frac{1}{{‖ {w}_{k}^{l} ‖}_{2}^{2 p} + {ε}^{p}}$$
where p is some positive exponent and ε is adaptively chosen to be ε=max {(min_{k,l}∥wₖ^{l}∥₂²),τ} and τ is some small positive value, and wherein αₖ^{l} is updated according to αₖ^{l}=ρₖ^{l}Rₖ+η, where η represents a tradeoff factor between backhaul rates and the transmission powers.

29. A system of designing sparse transmit beamforming for a network multiple-input multiple output (MIMO) system with limited backhaul, the system comprising:
a cloud central processor; and
a plurality of transmission points coupled to the cloud central processor by backhaul links and configured to serve a plurality of user equipment,
wherein the cloud central processor is configured to:
dynamically form a cluster of transmission points (TPs) for use in transmit beamforming for each of a plurality of user equipment (UEs) in the system by optimizing a network utility function and system resources;
determine a sparse beamforming vector for each UE according to the optimizing; and
transmit a message and first beamforming coefficients to each TP in the formed cluster associated with a first UE in the plurality of UEs, wherein each TP in the formed cluster associated with the first UE correspond to nonzero entries in a first beamforming vector corresponding to the first UE.

30. The system of claim 29, wherein dynamically and adaptively form a cluster of TPs comprises one of maximize a utility function with fixed system resources and minimize system resources with a given user experience constraint.

31. The system of claim 30, wherein the utility function comprises a weighted sum rate and the system resources comprise transmit power and backhaul rates.

32. The system of claim 29, wherein the system resources comprise transmit power and backhaul rates.

33. The system of claim 29, wherein iteratively minimizing required system resources comprises minimizing a weighted sum of transmit powers and backhaul rates, and wherein the at least one desired user experience constraint comprises user transmission data rates.

34. The system of claim 29, wherein the cloud central processor is further configured to iteratively:
compute a minimum mean square error (MMSE) receiver and a corresponding MSE;
update an MSE weight;
find an optimal transmit beamformer under a fixed utility function and MSE weight;
compute an achievable transmission rate for a user equipment, k; and
update a fixed transmission rate and a fixed weight to be equal to the achievable transmission rate.

35. The system of claim 29, wherein the cloud central processor is further configured to iteratively remove a first one of the transmission points from a user's candidate cluster once transmit power from the first BS to the user is below a threshold.

36. The system of claim 29, wherein the cloud central processor is further configured to ignore a first one of the user equipment when an achievable user transmission rate for the first one of the user equipment is below a threshold.

37. The system of claim 29, wherein the utility function is a weighted rate sum of user rates and wherein pre-specified system resources constraints comprise transmit power constraints and backhaul rate constraints.

38. The system of claim 29, wherein the cloud central processor is further configured to iteratively:
minimize a function of transmission powers and backhaul rates according to:
$$\begin{matrix}minimize \\ {w}_{k }^{l}\end{matrix} {\sum }_{k , l} {α}_{k}^{l} {‖ {w}_{k}^{l} ‖}_{2}^{2} subject to {SINR}_{k} \geq {γ}_{k} , ∀ k$$
where αₖ^{l}=ρₖ^{l}Rₖ+η, where ρₖ^{l} is a weight associated with each transmission point-user equipment pair, Rₖ is an effective transmission rate of user k, and η is a scalar;
find an optimal dual variable using a fixed-point method;
compute an optimal dual uplink receiver beamforming vector;
update the beam forming vector and δₖ, wherein δₖ is a scaling factor relating uplink optimal receiver beamforming and downlink optimal transmit beamforming; and
update weights, ρₖ^{l}, associated with each transmission point-user equipment pair, according to:
$${ρ}_{k}^{l} = \frac{1}{{‖ {w}_{k}^{l} ‖}_{2}^{2 p} + {ε}^{p}}$$
where p is some positive exponent and ε is adaptively chosen to be ε=max {(min_{k,l}∥wₖ^{l}∥₂²),τ} and τ is some small positive value, and wherein αₖ^{l} is updated according to αₖ^{l}=ρₖ^{l} Rₖ+η, where η represents a tradeoff factor between the backhaul rates and the transmission powers.
